(19) United States
(12) Patent Application Publication
(10) Pub. No.: US 2024/0209837 A1
(43) Pub. Date: Jun. 27, 2024

(54) INSTALLATION FOR THE COMBINED CONVERSION OF WAVE, WIND AND SOLAR ENERGIES INTO ELECTRICAL ENERGY

(71) Applicant: Nicolae Ghinda, Hammond (CA)

(72) Inventor: Nicolae Ghinda, Hammond (CA)

(21) Appl. No.: 18/085,729

(22) Filed: Dec. 21, 2022

(51) Int. Cl. F03D 9/00; F03B 13/00; H02K 7/18; H02S 10/12; H02S 10/40; H02S 20/32; H02S 40/22; H02S 40/32

(52) U.S. Cl. CPC F03D 9/007; F03B 13/00; H02K 7/183; H02S 10/12; H02S 10/40; H02S 20/32; H02S 40/22; H02S 40/32; F05B 2240/93

(57) ABSTRACT

The invention refers to a combined power generator for near shore area wherein on a support frame are mounted, at the base a vertical wave turbine coupled by means of a ratchet coupling to a wind turbine coupled in its turn by means of a speed raising coupling to an electric generator and above a photovoltaic platform with solar tracking system, with bi-facial photovoltaic panels, with a system of mirrors for the reflection of light on the back of the bi-facial photovoltaic panels, a hybrid controller and an inverter for taking over the electricity from the electric generator and the photovoltaic panels respectively and the transformation to the corresponding parameters for sending into the electrical network. By placing the convertors vertically and interconnected in an installation and by creating a network of such installations (energy parks) it is achieved an increase in energy efficiency on the surface unit and the efficiency of the near-shore areas. Other advantages of the installation are: constructive simplicity, low price of construction, maintenance and operation, wave breaker.

### FIELD OF THE INVENTION

The invention relates to the field of renewable energy sources, namely the installations for the combined conversion of wave, wind and solar energies into electrical energy in the nearshore areas.

### BACKGROUND

There are known renewable energy installations/platforms that combine the conversion of the three types of renewable energy (solar, wind, waves) into electrical energy.

We can list in this respect the patent “Complex generator using solar and wind and wave”—WO 2008/102980 A1, the patent “Generation of electric power using wave motion, wind energy and solar energy”—U.S. Pat. No. 10,526,056.B1, the platform “Floating multipurpose platform” developed by SINN Power company and the “Flex2power” platform developed by Worley company.

They have the disadvantage that they are more complex, requiring high construction, maintenance and operation costs, and the three converters are placed dispersed, independently of each other.

Wave/wind turbines are not interconnected and are not designed to work in both regimes (wave/wind) depending on the height of the waves.

Also, there are known photovoltaic platforms/structures equipped with solar tracking system but which have not been adapted to the nearshore areas and nor interconnected with the other renewable energy converters (wind and waves).

### SUMMARY OF THE INVENTION

A technical problem that the invention solves is the minimization of the area occupied by the three interconnected converters.

Designing of turbines that can work in both modes (wind/waves) and be vertically coupled without disturbing each other is the second technical problem solved.

The third technical problem solved is the development of a photovoltaic structure with tracking system and with a support frame which comprises wave and wind turbines, in nearshore areas.

The installation for the combined conversion of wave, wind and solar energies into electrical energy according to the invention is characterized by the interconnected mounting, on the same support frame, vertically of the three renewable energy converters, namely:
at the base a wave turbine whose vertical axis has a flywheel mounted at the bottom end and at the top end is coupled by means of a ratchet coupling at the bottom end of the axis of a wind turbine, which in its turn at the upper end is coupled by means of a speed-raising coupling to an electric generator;
above and supported on the support frame is mounted a platform with solar tracker system on which are placed bifacial solar panels and a system of mirrors for reflecting light on the back of the solar panels and also a hybrid controller and an inverter for taking over the electricity from the electric generator and from the photovoltaic structure and transforming it to the appropriate parameters for sending into the electrical network;
a second mirror system is installed on the side of the support frame.

The two turbines designed to work both in wave and wind regime (being practically identical) are characterized by the fact that they have fixed radially vertically on the axis several groups of three metal arms; at the outer ends of the lower and upper arm are fixed with the help of hinges some blades of aerodynamic shape and the arm in the middle has the role of support to prevent the destruction of the blades when subjected to high forces of the waves/winds.

The ratchet coupling is characterized by the superposition of two neck flanges, one mounted at the upper end of the wave turbine axis with some teeth at the upper edge of this flange and the second mounted at the bottom end of the wind turbine axis on which is mounted a lever supported on a support, lever that is oriented to get stuck in the teeth when the wave energy is significant compared to the wind energy so that the two turbines simultaneously transmit energy to the electric generator unless when the wave energy is insignificant, the ratchet performing in this case the decoupling of the wave turbine.

In order to increase the stability of the installation in the field, some rectangular metal frames supported on concrete blocks are mounted in the corners on the diagonal, or in the case of making a network of installations (energy park) they are fixed diagonally to each other by means of these frames for fixing.

If the installation in the field is more difficult and expensive, the installation can be mounted on a pontoon with fixing anchor and also a network of installations (energy park) could be mounted on pontoons that can be coupled to each other with some articulated arms.

### BRIEF DESCRIPTION OF THE DRAWINGS

Other advantages and characteristics emerge more clearly from the following description presented on the basis of a non-limiting embodiment of the invention and represented in the attached drawings in which:

FIG. 1 illustrates a lateral view of the installation;

FIG. 2 illustrates a view from above of the wave turbine of the installation of FIG. 1;

FIG. 3 illustrates a lateral (partially) cross-sectional view of the ratchet coupling of FIG. 1;

FIG. 4 illustrates a schematic view from above of a network of installations;

FIG. 5 illustrates a front view of an installation fixed on a pontoon;

FIG. 6 illustrates a schematic view from above of a network of installations placed on pontoons.

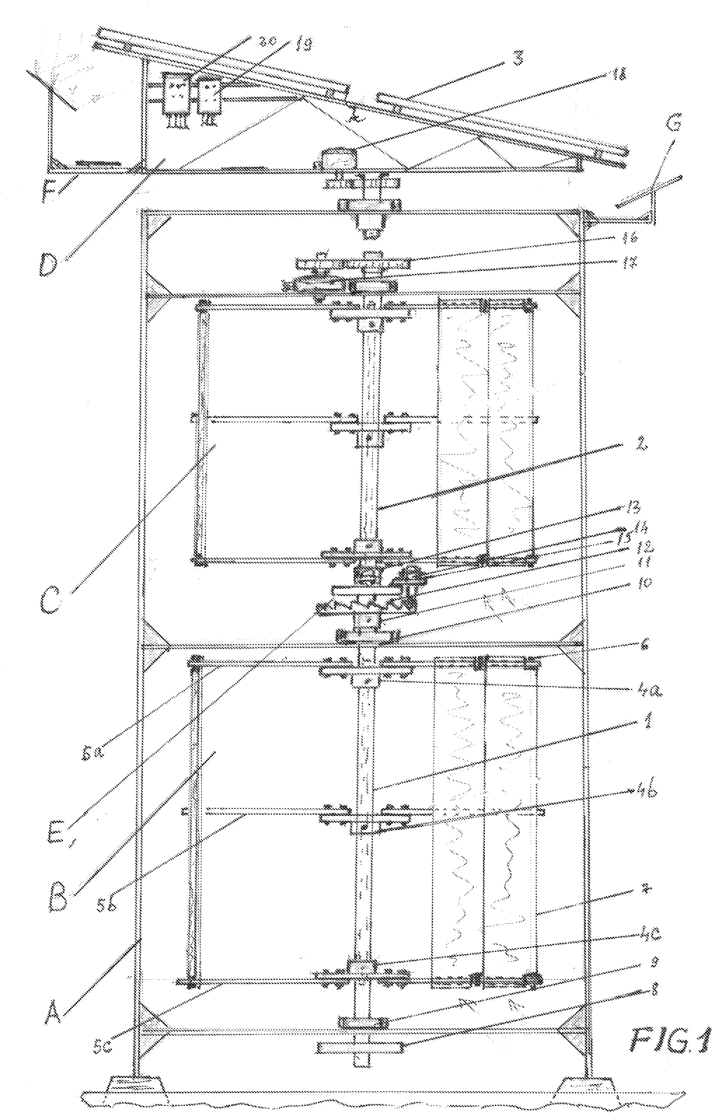

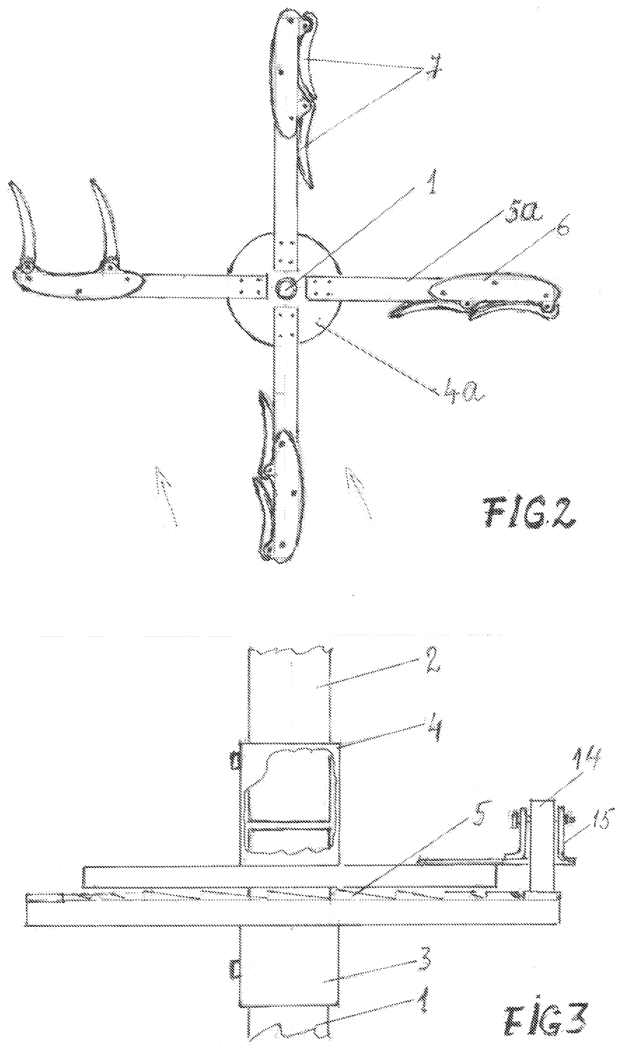

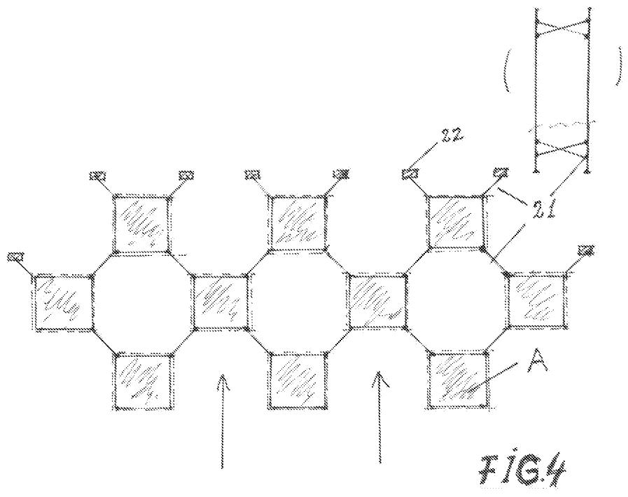

### DETAILED DESCRIPTION OF THE INVENTION

The installation for the combined conversion of wave, wind and solar energy, according to the invention as seen in FIG. 1 is composed of a support frame A on which are mounted vertically, superposed and interconnected three converters: a wave turbine B with vertical axis 1, a wind turbine C with vertical axis 2 and a photovoltaic platform D with bifacial PV panels 3.

Taking into account that sometimes the height of the waves can exceed the height of the wave turbine B exercising force also on the wind turbine C, the two turbines are designed to work both in wave and wind regimes being practically identical.

The wave turbine B has mounted on the vertical axis 1 some neck flanges 4a, 4b, 4c on which are fixed four groups of three arms each 5a, 5b, 5c.

At the outer part of the arms 5a and 5c are fixed with some hinges 6 some blades 7 of aerodynamic shape as in FIG. 2.

The middle arm 5b has the role of support for the blades 7 when subjected to very high wave/wind forces.

The axis 1 of the wave turbine B which has at the lower end mounted a flywheel 8 for the uniformization of the rotational movement, passing through a submerged bearing 9 and a roller bearing 10 is connected to the lower end of the vertical axis 2 of the wind turbine C by means of a ratchet coupling E. The ratchet coupling E consists of a neck flange 11 fixed at the top of the axis 1, having some teeth 12 on the edge at the top and a neck flange 13 of smaller diameter and fixed on the axis 2 in which the end of the axis 1 partially enters and on which is mounted a mobile lever of blockage 14 supported on a support 15 that allows the relative rotation of turbines B and C in only one direction.

More precisely, when the waves act on the blades of turbine B the lever 14 gets stuck in the teeth 12 and thus is engaged in rotational motion the axis 2 of the wind turbine C that transmits the rotational movement through a speed increaser transmission system 16 to a generator 17. In the absence of waves and in the presence of the wind, the lever 14 slides on the teeth and the wave turbine is disengaged.

On the platform D equipped with a solar tracker system 18 and mounted on the support frame A, it is mounted a system of mirrors F for reflecting the light on the back of the bifacial photovoltaic panels 3 and also a hybrid controller 19 and an inverter 20 for taking over the electricity from the generator 17 and from the PV panels 3 and bringing it to the suitable parameters for transmission in the electrical network.

In addition, a mirror system G is mounted on the sides of the support frame A also for illuminating the back of the bifacial panels 3.

In order to better fix the support frame A in the bed sea, some rectangular fixing frames 21 resting on some concrete blocks 22 are coupled in the corners diagonally, or in the case of making a network of installations (energy park) they are fixed to each other with the help of fixing frames 21.

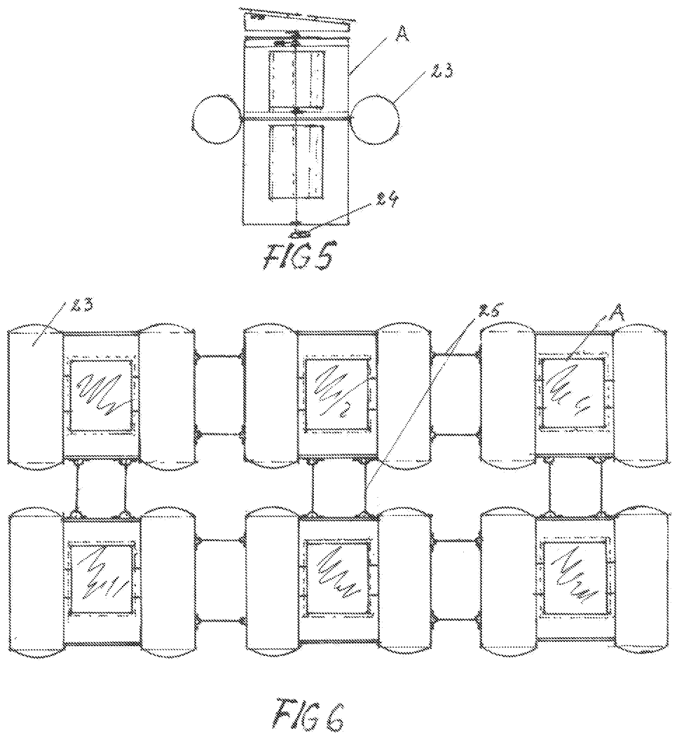

In areas where the fixing of the support frame A on the bottom of the sea bed is difficult and/or expensive the installation can be mounted a on a pontoon 23 with the fixing anchor 24 as in FIG. 5. And in the case of building a network of floating installations, the pontoons 23 are coupled with the help of articulated arms 25 as in FIG. 6.

By applying the invention, the following advantages are obtained:
constructive simplification;
low price of building, maintenance and operation;
more efficient use of the nearshore areas;
increasing the energy conversion efficiency per surface unit;
wave breaker for protecting the shore;
the possibility to adapt the size of the installations as well as the configuration of the network of installations to the specific conditions of each near shore area.

1. An installation for the combined conversion of wave, wind, and solar energy into electricity, the installation comprising:
a support frame having mounted vertically and interconnected a wave turbine with a vertical axis wherein at the bottom end of the axis having a flywheel and at the upper end being coupled by means of a ratchet coupling to the bottom end of the axis of the wind turbine and at the upper end being coupled by means of a speed raising coupling to an electric generator;
above the support frame and supported by it, a photovoltaic platform (structure) comprising: a solar tracking system, bifacial solar panels, a mirror system, a hybrid converter and an inverter for transmission of electrical energy at the parameters corresponding to the electrical network;
on the side of the said frame support, a second system of mirrors for the reflection of sunlight on the back of the bifacial solar panels.

2. The installation of claim 1, wherein the two turbines are designed to work in both wind/wave regimes depending on the height of the waves, being practically identical, wherein more precisely the respective turbines comprising three neck flanges mounted on the vertical axis and on which several groups of three arms are fixed radially and at the outer part of the upper and lower arms being fixed with some hinges some blades of aerodynamic shape and the middle arm having the role of support for the blades at high forces of the waves/wind.

3. The installation of claim 1, wherein the wave turbine with vertical axis being coupled with the wind turbine by means of a ratchet coupling wherein more precisely a neck flange fixed to the upper part of the axis of the wave turbine having some teeth on the upper edge and a neck flange with a smaller diameter fixed to the bottom of the axis of the wind turbine in which the upper end of the axis of the wave turbine is partially inserted and on which a locking lever is mounted resting on a support fixed to this flange allowing the relative movement of the wind and wave turbines in only one direction, for the coupling/decoupling of the wave turbine depending on the power of the waves in relation to that of the wind.

4. The installation of claim 1, wherein the said photovoltaic structure comprising: a solar-tracking system, bifacial solar panels, a system of mirrors for the reflection of light on the back of bifacial solar panels, a hybrid controller and an inverter, having as support base the said support frame containing: a wave turbine further coupled by means of a ratchet coupling to a wind turbine, the turbine being in turn coupled by means of a speed increaser coupling to an electric generator and wherein the said support frame being fixed either in the sea bed or mounted on a pontoon; the structure being thus adapted to the near shore areas.

5. The installation of claim 1, wherein some rectangular metal frames are connected at the corners and diagonally and supported either on some concrete pillars, either connected to the neighboring installations in the case of a network of installations (energy park) to increase stability in the field.

6. The installation of claim 1, wherein the said installation is mounted on a pontoon and fixed in the ground with a fixing anchor or fixing cables.

7. The installation of claim 1 or 6, wherein the said installation mounted on a pontoon being laterally coupled by means of some articulated arms to other neighboring installations for the realization of a network of floating installations (floating energy park).
